(19) United States
(12) Patent Application Publication
(10) Pub. No.: US 2014/0022123 A1
(43) Pub. Date: Jan. 23, 2014

(54) SYSTEM FOR MANAGING MULTIPLE, INDEPENDENTLY-POSITIONED DIRECTIONAL ANTENNA SYSTEMS MOUNTED ON A SINGLE VEHICLE WITHIN A WIRELESS BROADBAND NETWORK

(71) Applicant: Broadband Antenna Tracking Systems, Inc., Indianapolis, IN (US)

(72) Inventors: Robert Lee Bruder, Zionsville, IN (US); Steven Douglas Bensen, Zionsville, IN (US); Matthew Charles Creakbaum, Carmel, IN (US); Robert Baldur Peterson, Zionsville, IN (US)

(21) Appl. No.: 14/035,443

(22) Filed: Sep. 24, 2013

Related U.S. Application Data
(63) Continuation of application No. PCT/US2012/030305, filed on Mar. 23, 2012.
(60) Provisional application No. 61/467,694, filed on Mar. 25, 2011.

(51) Int. Cl. H01Q 3/12

(52) U.S. Cl. CPC H01Q 3/12
USPC 342/359

(57) ABSTRACT

A system and method for automatically coordinating different remote broadband communications sources using multiple directional antennas mounted on a single vehicle and automatically tracking the signal sources in accord with the coordination. The system scans the horizon to identify all available signals being respectively received from the plurality of remote broadband wireless communication sources. The signals or sources are then ranked based on an optimization criteria. Based on the criteria, a first directional antenna is positioned to allow two-way communication with the first remote broadband communication source and the second directional antenna is positioned to allow two-way communication with the second remote broadband communication source.

### CROSS-REFERENCE TO RELATED APPLICATIONS

This application is a continuation of International Application No. PCT/US2012/030305 filed Mar. 23, 2012, which claims the benefit of U.S. Provisional Patent Application Ser. No. 61/467,694 filed Mar. 25, 2011, the entire disclosures of which are hereby incorporated by reference.

### FIELD OF THE INVENTION

The present invention generally relates to wireless broadband communication systems. More particularly, the present invention pertains to a system for managing multiple directional broadband antenna systems mounted on a single vehicle.

### BACKGROUND

Various communications systems are known in the art which allow moving vehicles, such as ships, aircraft, or terrain vehicles, to communicate with other moving vehicles or fixed communication installations. Because it is not feasible to connect a moving vehicle to a communication system using a wired medium, wireless methods are often employed. One such method is to use satellite communications to allow the vehicle to communicate with the intended target. However, satellite communications suffer from significant drawbacks, such as limited bandwidth, increased latency, and instability due to weather conditions or other environmental effects.

Another alternative is to use a single antenna on the vehicle to establish communications with another vehicle or communication node using a broadband wireless communication network. However, in addition to the challenges presented by the fact that the vehicle is moving in relation to the communication target, it may further be difficult to maintain communication with multiple communication sources using the single antenna, as is often required in multi-vessel or vehicle communications environments, such as mesh networks. Commonly-used omni-directional antennas in such wireless systems are also not typically capable of achieving the desired speed and bandwidth necessary in modern data and video communications. Improved communication systems and methods are therefore needed in this area.

### SUMMARY OF THE INVENTION

According to one aspect of the disclosure, a system and method are presented for automatically coordinating different remote broadband communications sources using substantially different directional antennas mounted on a single vehicle and automatically tracking in accord with the coordination. The system identifies the signals and, based on differences in the characteristics of the signals and differences between the antennas, selectively pairs antennas to the individual signals or sources. The antenna selection is based on an optimization criteria which takes into account differences in the antenna characteristics and differences in the signal characteristics. The criteria may consider, for example, differences in the position or movement of wireless access points or signal sources. The criteria may also be based on signal strength, signal type, distance, bandwidth requirements, as well as data derived from the signal sources, such as GPS coordinates, heading, velocity, etc. The criteria may also consider whether the sensed source includes a network topology manager, or the number of wireless links from the sensed signal source to a network topology manager.

The system repositions the directional antennas in order to establish and maintain network links with two or more other vehicles or remote broadband wireless communication sources in the network. This allows the communication systems of the vehicle to extend the geographical topology of the network, establish and maintain multiple communication links within one or more networks, and allow communicated information that is received by the vehicle or vessel to be passed along within the network through the other independently positioned directional antenna(s).

The ability to establish and maintain a wireless network with one of the independently positioned antenna also allows the communications system (onboard the vehicle or vessel) to acquire information about other wireless broadband sources in the network, and derive information that can direct the operator to move the vehicle or vessel in a specific direction or heading, thereby allowing the second independently positioned directional antenna to acquire a new wireless network link with another access point or signal source. Furthermore, the onboard management of two or more distinct directional antennas that have different gain levels, beam widths, or other reception characteristics in relation to the received signals, allows the management system to prioritize which antenna will be used in different specific network topology positions, data and bandwidth demands, as well as considerations for specific network services that are available at different wireless access points or signal sources.

### BRIEF DESCRIPTION OF THE DRAWINGS

FIG. 1 is a diagrammatic view of a system for managing multiple independent antenna systems mounted to a vehicle according to one embodiment of the present disclosure.

FIG. 2 is a diagrammatic aerial view of a vessel having multiple independent directional antennas mounted thereon.

FIG. 3 is a process flow diagram illustrating one set of steps performed in enabling communication between the vessel of FIG. 2 and a remote broadband wireless communication network using the system of FIG. 1.

FIG. 4 is a diagrammatic aerial view of the vessel of FIG. 2 engaged in communication with two remote broadband wireless signal sources using the system of FIG. 1 according to one embodiment.

FIG. 5 is a diagrammatic aerial view of the vessel of FIG. 2 engaged in communication with two remote broadband wireless signal sources using the system of FIG. 1 wherein the vessel is moving away from one of the signal sources at a faster rate than the other signal source.

FIG. 6 is a diagrammatic aerial view of the vessel of FIG. 2 engaged in communication with two remote broadband wireless signal sources using the system of FIG. 1 wherein one of the signal sources includes a network topology manager.

FIG. 7 is a diagrammatic aerial view of the vessel of FIG. 2 engaged in communication with two remote broadband wireless signal sources using the system of FIG. 1 wherein the signal sources are also remote communication with a network topology manager signal source.

FIG. 8 is a diagrammatic aerial view of the vessel of FIG. 2 engaged in communication with two remote broadband wireless signal sources using the system of FIG. 1 wherein one of the signal sources is capable of providing a relatively higher bandwidth connection than the other signal source.

FIG. 9 is a diagrammatic aerial view of the vessel of FIG. 2 engaged in communication with two remote broadband wireless signal sources using the system of FIG. 1 according to one embodiment.

### DETAILED DESCRIPTION

For the purposes of promoting and understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

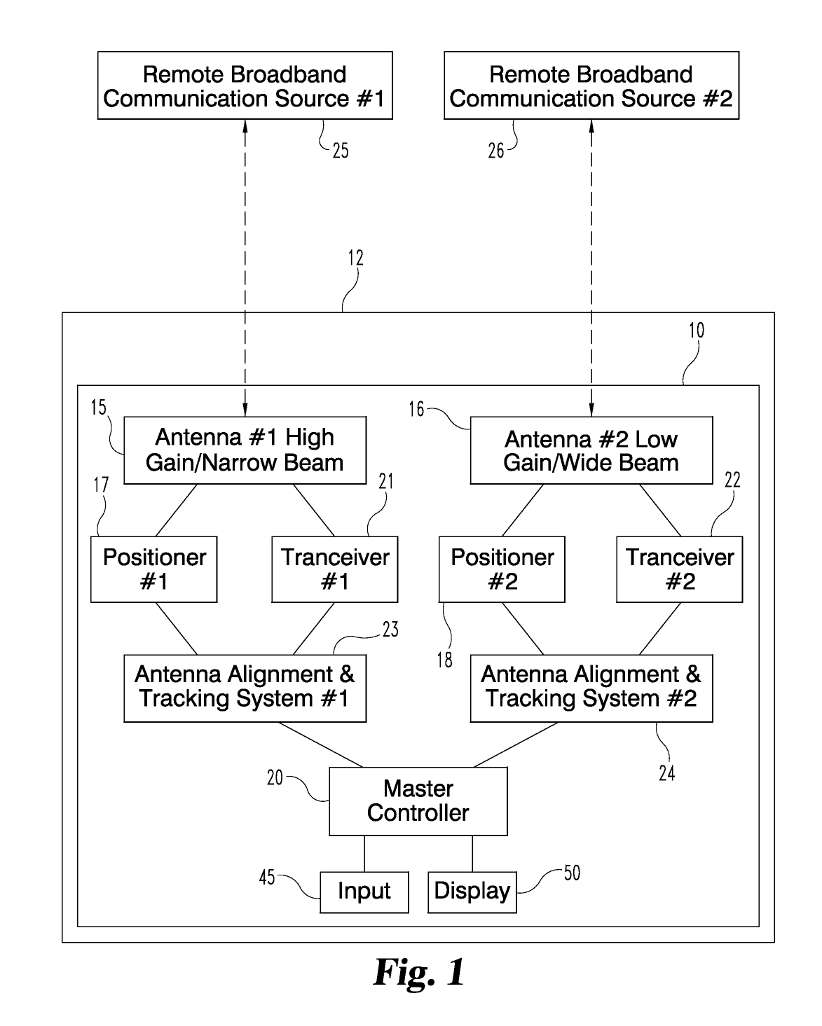

FIG. 1 illustrates a system 10 for managing multiple antennas 15 and 16 which are mounted onboard a vehicle 12, such as an aircraft, maritime vessel, or terrain vehicle. The antennas 15 and 16 are preferably directional in nature to allow communication with distant sources, but may have substantially different reception characteristics, such as gain levels, beam widths, or other differences due to their mounting locations on the vehicle. Due to their different reception characteristics, one of the antennas may be capable of communicating over great distances (e.g., 50 miles or more), while another antenna may be relatively limited in its reception capabilities. It shall be understood that the range of both antennas may be higher or lower than 50 miles, and the mentioned range is only one non-limiting example of the ranges contemplated to be within the scope of the present disclosure. The antennas 15 and 16 are each respectively connected to a positioner 17 and 18 and a transceiver 21 and 22 as shown. The positioners 17 and 18 comprise the hardware necessary (motors, gearing, etc.) to physically move or rotate the antennas about a horizontal and vertical axis. In addition to physical rotation and movement, the antennas may be electronically steered. The tranceivers 21 and 22 provide for the tuning, amplification and other processing of the signals received and transmitted by antennas 15 and 16.

Each antenna is operatively connected to a respective antenna and alignment tracking system (AATS) 23 and 24 as shown. Each AATS 23 and 24, via the positioners 17 and 18 and transceivers 21 and 22, automatically senses and/or tracks a desired signal or signal source location, and may also account for changes in the vehicle position. It shall be understood that positioners, transceivers, and/or antennas may be included within each AATS 23 and 24 or provided as separate components. One example of a suitable AATS which contains a positioner, transceiver, antenna and associated control components is the model AMATS-300/RMCU-2500 system supplied by BATS Wireless, Inc., 8902 Vincennes Circle, Indianapolis, Ind. 46268. It shall be further understood that more than two antennas, positioners, transceivers and AATS units may be provided and operated using the system 10 to communicate with more than two corresponding remote broadband communication sources.

The system 10 further comprises a master controller 20 which is in operative communication with each AATS' 23 and 24 as shown. The master controller 20 selectively pairs the individual antennas 15 and 16 with signals or sources based on various optimization criteria as discussed in detail below. In certain embodiments, the master controller 20 contains information relating to signal sources in addition to those detected during the scanning process. For example, the master controller 20 may be preloaded with a list of all of the available signal sources in the network and their associated properties. In other embodiments, the master controller 20 may determine the list of available signal from the information received during the scan process. In still further embodiments, the master controller 20 may also provide node awareness or other information to other vehicles or signal sources in the network based on the information preloaded in or dynamically determined by the master controller 20.

When positioned correctly, the antennas 15 and 16 enable two-way broadband wireless communication with two or more remotely located broadband wireless signal sources 25. The remote signal sources 25 may comprise any device capable of transmitting or receiving broadband signals using a wireless protocol. One example of such a device is a Wireless Access Point which conforms to IEEE 802.16 or IEEE 802.11 standards. The remote signal sources 25 are typically located on other moving vehicles to collectively form a mesh network. The antennas 15 and 16 send and receive signals to and from the remote signal sources 25 and 26, which are likewise directed to and from the vehicle communication subsystems (or retransmitted to other vehicles). Because each vehicle or signal source in the network is also capable of retransmitting signals received from one vehicle to other vehicles, communication over hundreds or even thousands of miles becomes possible.

The master controller 20 may also comprise a processor for processing data and memory for storing data. The controller 20 may also be operatively coupled to an input device 45 for receiving user-entered data, and an output display device 50 for displaying data. In other embodiments, the system 10 may contain fewer or more components. AATS' 23 and 24 may also likewise comprise similar processor, memory, and input/output devices. It shall also be understood that in certain embodiments, the functionality of the master controller 20 may be incorporated into one or more of the AATS units 23 or 24.

The master controller 20 is used to control the operation of the system 10 by analyzing the various forms of information discussed herein and dictating wireless signal source and antenna pairings and/or antenna movements. The master controller 20 may be comprised of one or more components. For a multi component form, one or more components may be located remotely relative to the others, or configured as a single unit. Furthermore, the controller 20 can be embodied in a form having more than one processing unit, such as a multi-processor configuration, and should be understood to collectively refer to such configurations as well as a single-processor-based-arrangement. One or more components of the processor may be of electronic variety defining digital circuitry, analog circuitry, or both. The processor can be of a programmable variety responsive to software instructions, a hardwired state machine, or a combination of these.

Among its many functions, the memory of master controller 20 in conjunction with the processor is used to store information pertaining to, such as, but not limited to, antenna position, vehicle location, GPS location, heading, speed, services delivered through the network, signal strength, distance between vehicles or vessels etc., on a temporary, permanent, or semi-permanent basis. The memory can include one or more types of solid state memory, magnetic memory, or optical memory, just to name a few. By way of nonlimiting example, the memory can include solid state electronic random access memory (RAM), sequential access memory

(SAM), such as first-in, first-out (FIFO) variety or last-in, first-out (LIFO) variety, programmable read only memory (PROM), electronically programmable read only memory (EPROM), or electronically erasable programmable read only memory (EEPROM); an optical disc memory (such as a blue-ray, DVD or CD-ROM); a magnetically encoded hard disc, floppy disc, tape, or cartridge media; or a combination of these memory types. In addition, the memory may be volatile, non-volatile, or a hybrid combination of volatile, non-volatile varieties. The memory can further include removable types of memory. The removable memory can be in the form of a non-volatile electronic memory unit, optical memory disk (such as a blue ray, DVD or CD ROM); a magnetically encoded hard disk, floppy disk, tape, or cartridge media; a USB memory drive; or a combination of these or other removable memory types.

The input device 45 can include any type of input device as would occur to those skilled in the art, such as buttons, microphones, touch screens, keyboards, and the like, to name a few examples. The output device 50 can include output devices of the type as would occur to those skilled in the art, such as displays, tactile devices, printers, speakers, and the like, to name a few examples. Moreover, it should be recognized that the input device and the output device can be combined to form a single unit such as, for example, a touch-type screen.

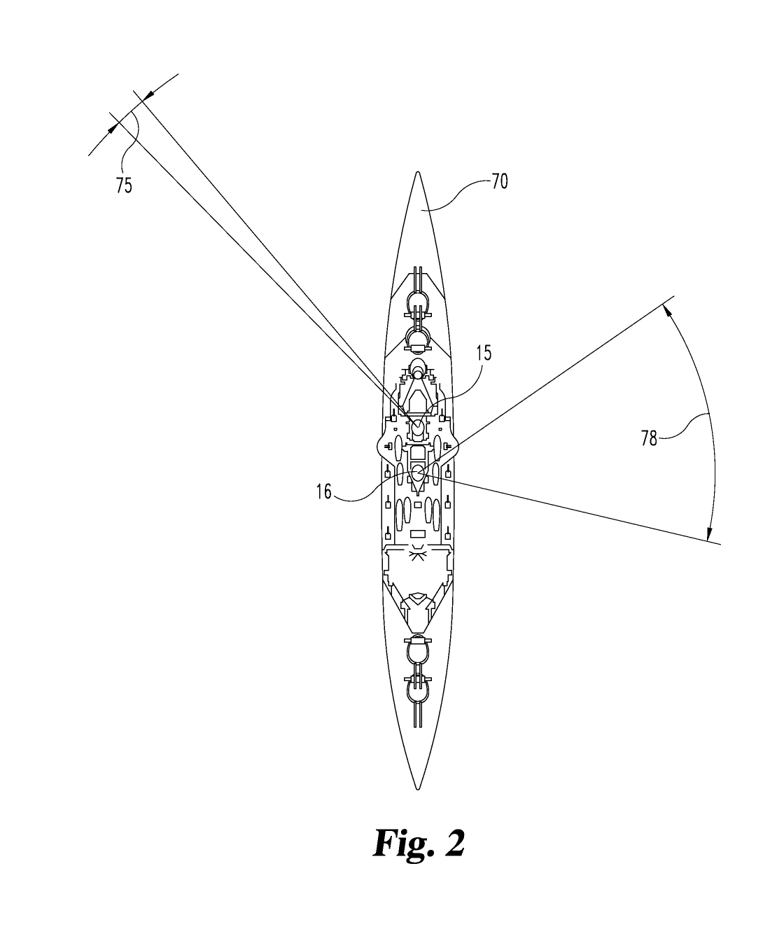

FIG. 2 depicts a vessel 70 which utilizes the system 10 to manage multiple antennas, such as antennas 15 and 16. As shown, the first antenna 15 has a relatively higher gain and/or a narrower focus beam 75 when compared to the second antenna 16, which has a relatively lower gain and/or a wider focus beam 78. In general, narrower focus antennas are capable of reaching further distances than wider focus antennas, although an antenna's reception and transmission capabilities may be based on other factors as well. As used in the specification and claims, the term “substantially different” with respect to antenna reception or transmission shall be interpreted to mean arising either out of differences in the antenna design or out of differences in antenna position in relation to the structure of the vehicle so as to give substantially different signal reception patterns or quality even if the antennas are otherwise identical.

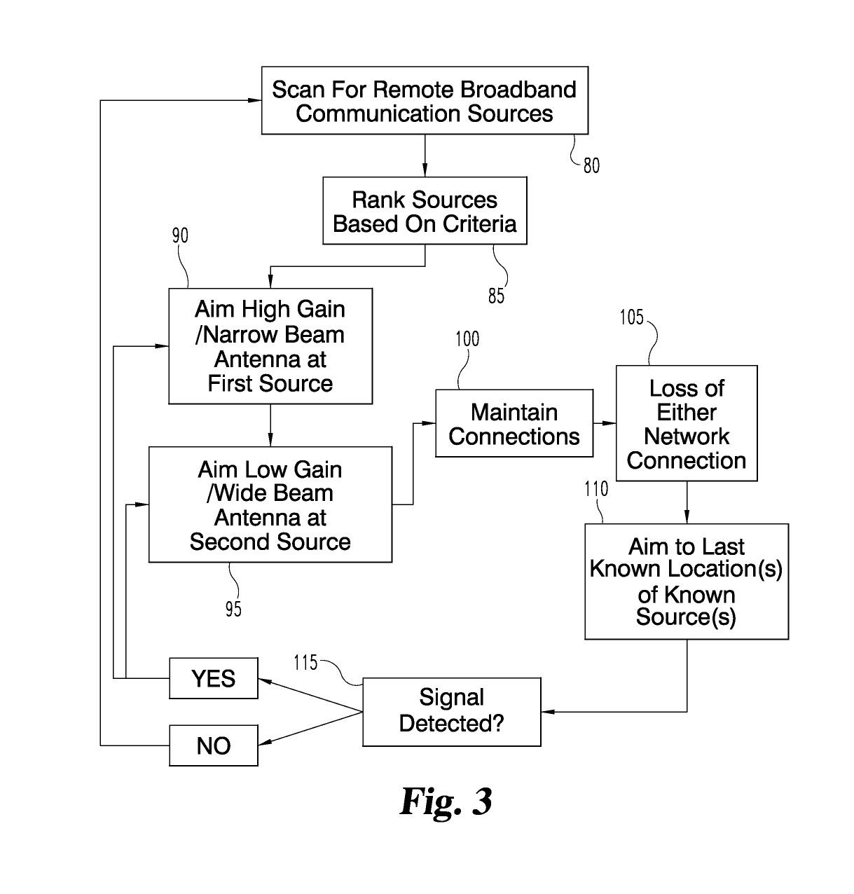

FIG. 3 illustrates a process for implementing the system 10. The process begins at step 80, when the master controller 20 directs one or more of the antennas 15 and 16 to scan the horizon and search for signals being transmitted by remote broadband communication sources, such as wireless access points located on other vehicles. It shall be understood that the scan may be performed by one or more of the multiple directional antennas, or by a separate omni-directional antenna capable of receiving a remote wireless beacon signal. It shall be further understood that the scan may be performed in both the horizontal axis and vertical axis to ensure the greatest possible coverage. As the system 10 detects potential broadband signal sources, the respective signal source locations or relative headings may be stored in memory by the master controller 20.

Once the list of available remote broadband signal sources is determined, the controller 20 ranks them according to an optimization criteria relating to the signal and antenna characteristics at steps 85. The master controller then directs the antenna alignment control systems 23 and 24 to position each antenna toward a corresponding signal source 25 and 26 at steps 90 and 95 to ensure the most optimal use of the antennas. The master controller 20 continues to monitor and maintain the connections over time (step 100). If one or more of the connections is lost or degrades in quality below an acceptable threshold (step 105), the controller 20 may attempt to redetect the lost signal by aiming the corresponding antenna toward the last known antenna position where a valid signal was received (step 110). If the signal is regained (step 115), the system again aims the antenna toward the assigned signal source and continues to monitor the signal. If the signal is not regained, the process starts over at block 80, and the horizon is rescanned for available signal sources, which may include the same original signals and/or additional signals which have become available since the previous scan.

Various optimization criteria may be used to determine the ranking and/or pairing of antennas to remote signal sources. In one embodiment, the pairing may be based on signal strength as received by the scanning antenna. For example, a relatively higher gain antenna may be assigned to a remote signal source having a relatively weaker signal in order to ensure that its signal is not lost. Likewise, a relatively weaker antenna may be assigned to a signal source having a relatively stronger output signal, thereby optimizing the available communication resources.

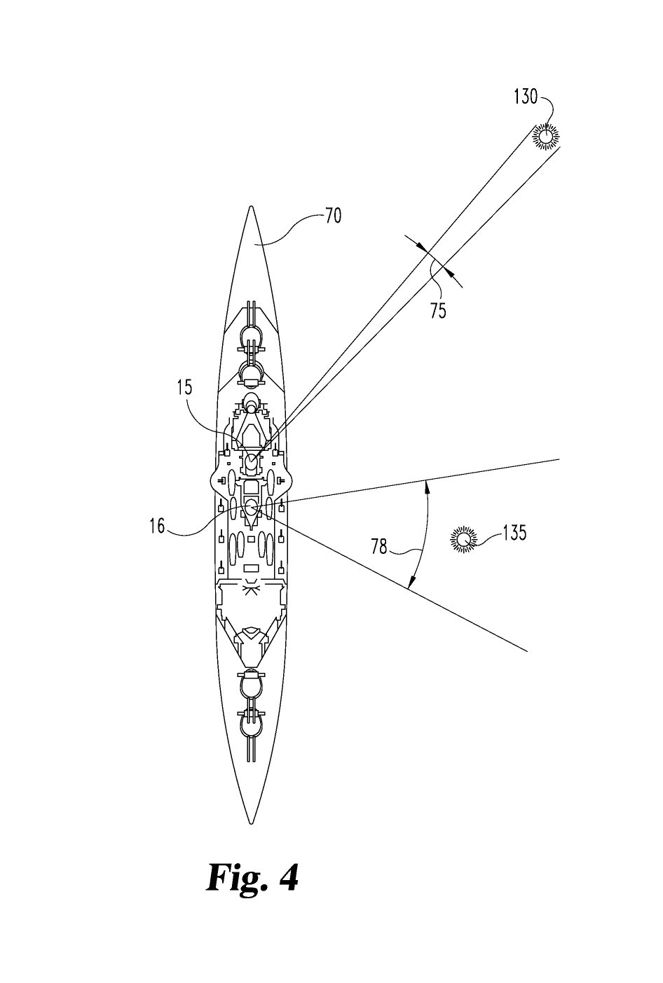

In other embodiments, the ranking and/or pairing of antennas to remote signal sources may be based on the distance from the vehicle to the respective signal sources. FIG. 4 illustrates one example where the vessel 70 has detected two wireless access points 130 and 135. In this embodiment, the controller 20 determines that the access point 130 is further from the vehicle than access point 135. This determination may be based on received signal strength, location information transmitted from the access points (e.g., global positioning satellite (GPS) information), or other methods known in the art. The master controller 20, via AATS 23, then directs the antenna 15, which has a higher gain and/or narrower beam focus 75, to aim toward the more distant access point 130. Likewise, the antenna 16, which has a wider beam 78 is aimed toward the closer access point 135.

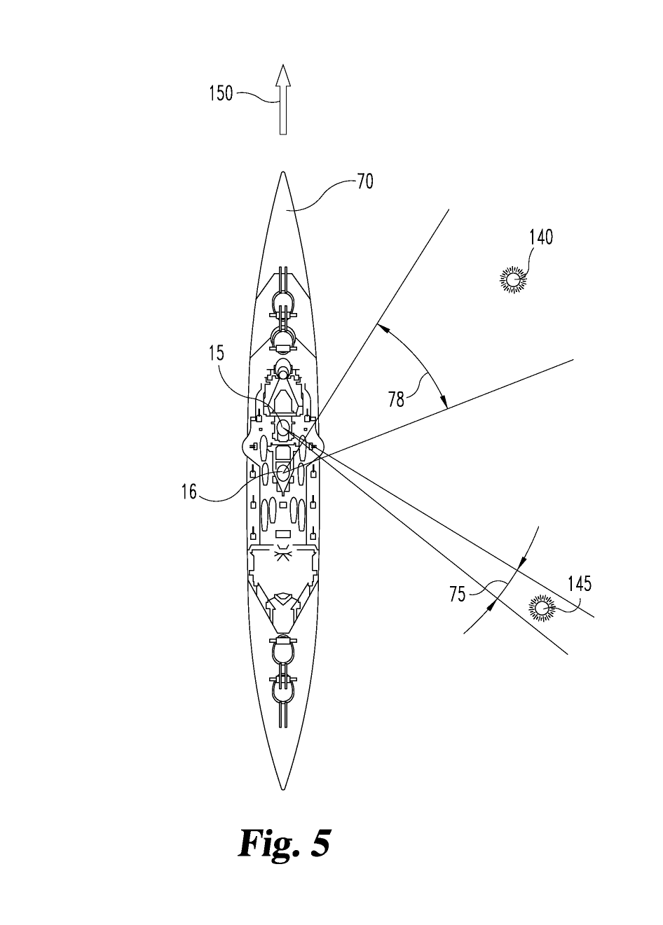

In still further embodiments, the ranking and/or pairing of the antennas to remote signal sources may be based on the predicted future relative distances based on movement of the vehicle and/or movement of the signal sources. For example, as shown in FIG. 5, if the vessel is moving in the direction indicated by arrow 150, the vessel 70 will be getting relatively closer to access point 140 over time and relatively farther away from access point 145. The master controller 20 may then direct antenna 15, which has a higher gain and/or narrower focus, to aim toward access point 145 in order to maintain the best possible signal reception as the vessel moves along its path. Likewise, antenna 16, which has a lower gain, will be aimed toward access point 140, since its received signal will become stronger as the vessel moves along its path.

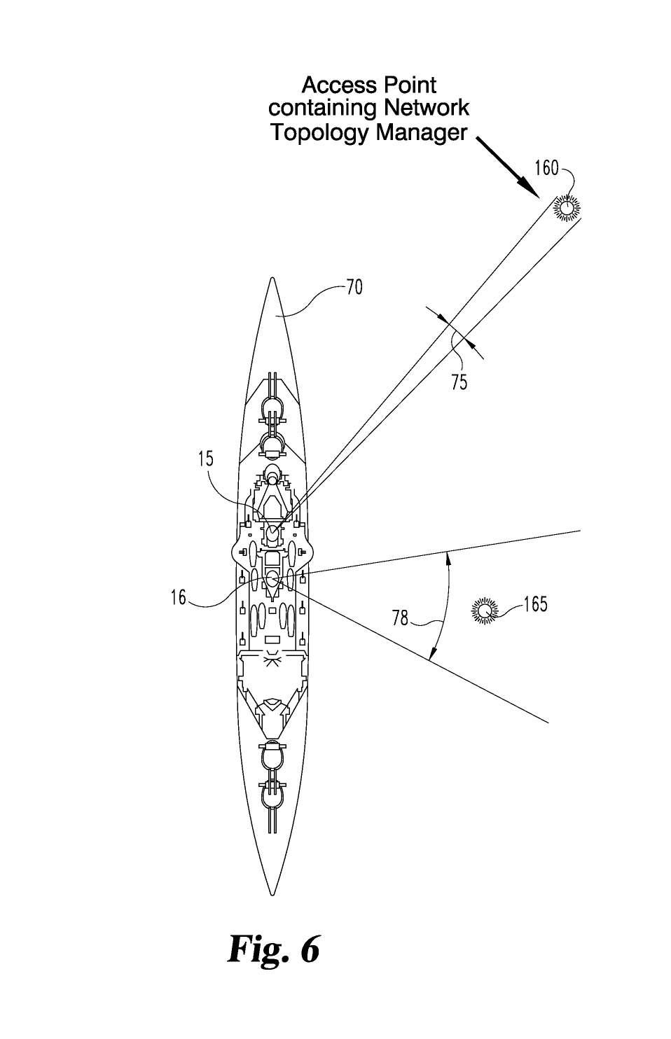

FIG. 6 illustrates yet another embodiment wherein the system 10 detects two remote access points 160 and 165. In this example, one of the access points (160) also operates as a network topology manager. An access point which includes a network topology manager is relatively more important to the communication network due to its enhanced control and monitoring functionality in the network, and may be deserving of preference in the ranking with respect to other access points. Because of this, the master controller 20 may assign the antenna having a higher gain or narrower focus (shown here as antenna 15, beam 75) to the network topology access point 160 and assign the lower gain antenna 16 to the remaining access point 165.

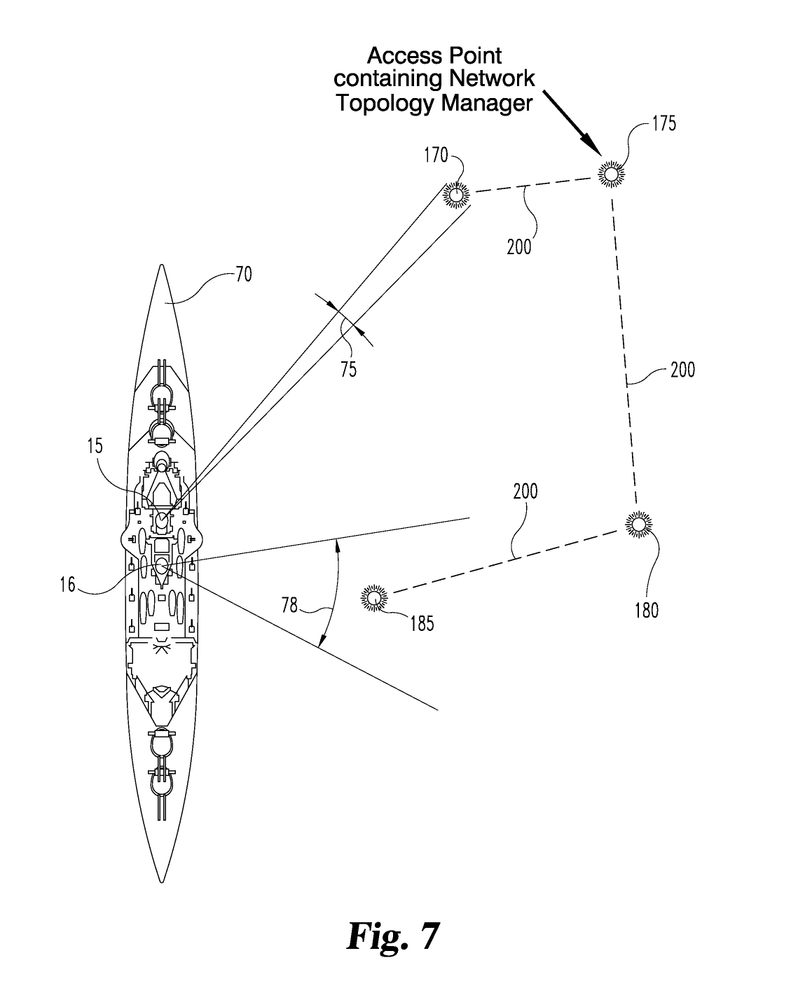

A further embodiment is shown in FIG. 7, wherein the vessel 7 has detected two remote access points 170 and 185. In this embodiment, the detected access points 170 and 185 are further connected to access points 175 and 180 by wireless links 200 as shown. When determining the ranking, the controller 40 determines how many wireless links are between the detected access points (170 and 185) and the access point 175 which has a network topology manager. The master controller 20 can determine the number of wireless links by electronically interrogating and exchanging network information with the access points via AATS 23 and/or 24. As shown, the access point 170 is only one link away from the topology manager access point 175, while the access point 185 is two links away from the topology manager access point 175. Therefore, a preference can be applied to the access point 170 based on its closer proximity to the topology manager. The higher gain/narrower beam antenna 15 will therefore be assigned toward access point 170 to optimize the communications. The lower gain antenna 16 will likewise be assigned to access point 185.

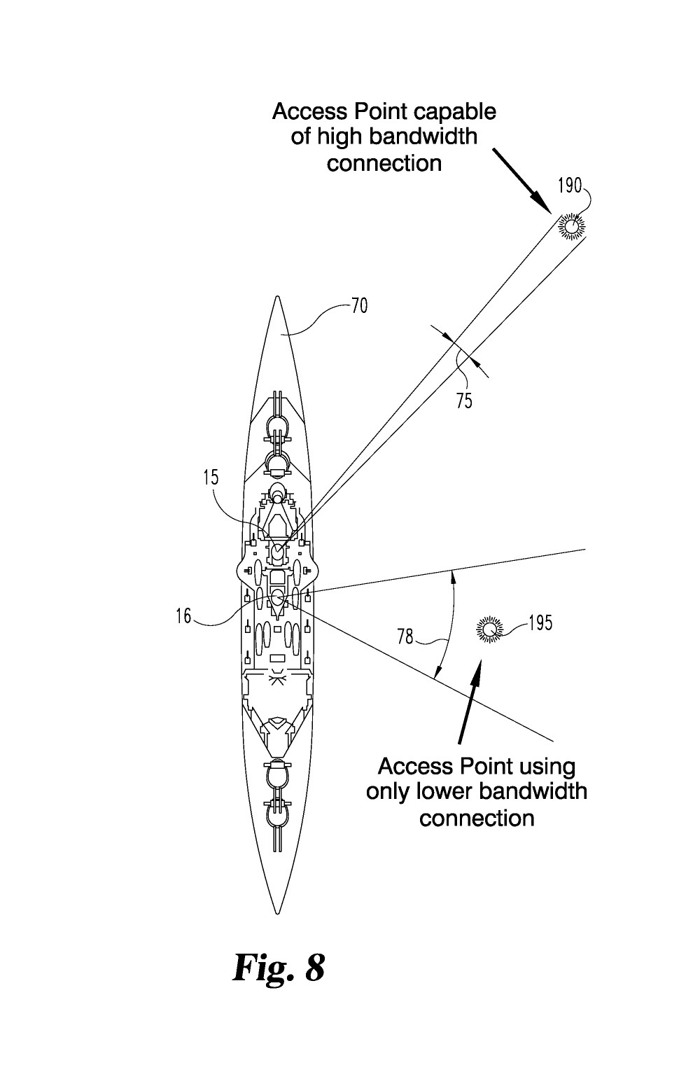

FIG. 8 illustrates a further embodiment wherein the system 10 has detected two remote access points 190 and 195. To determine the ranking, the system determines the bandwidth capabilities of each access point. For example, the signals received from the access point can be examined to determine how much bandwidth the access point requires or is currently using. The master controller 20 can then assign the stronger gain/narrow beam antenna to the access point requiring a higher bandwidth (signal source 190 as illustrated). Likewise, the access point 195 which requires less bandwidth can be assigned to the lower gain antenna 16.

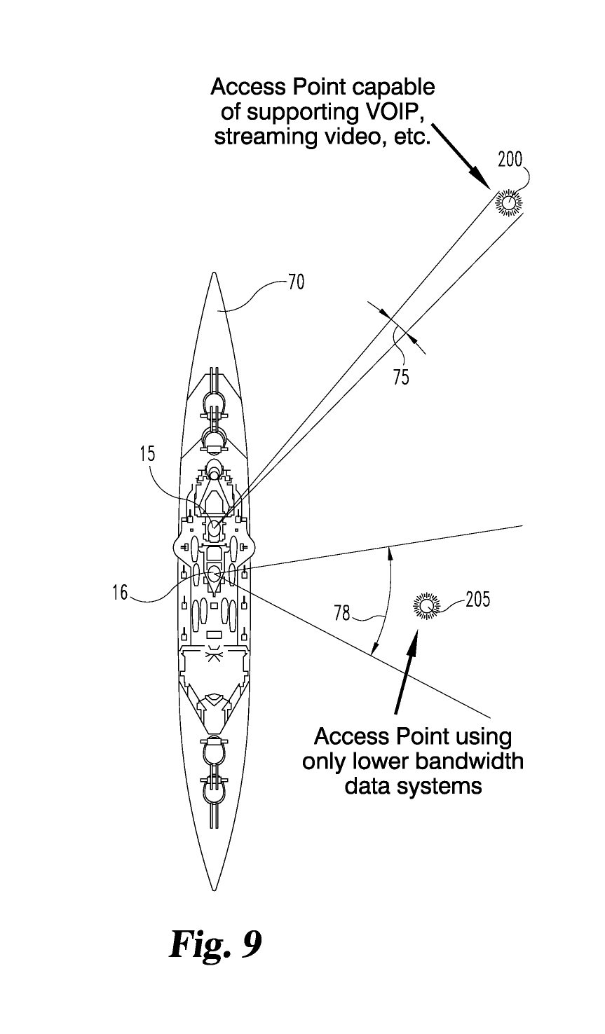

In still further embodiments, the ranking of remote signal sources and/or signals can be based on the type of signal or priority of data carries by the signal that each signal source is sending and/or receiving. For example, certain types of signals may require lower latency, such as voice-over-IP (VOIP) signals or high resolution video signals, whereas other types of signals can tolerate greater latency or may have a relatively lower importance. FIG. 9 shows one embodiment wherein two access points 200 and 205 have been detected. As shown, access point 200 is capable of or responsible for supporting voice-over-IP (VOIP), streaming video, and the like, and therefore may require a higher gain antenna to maintain acceptable signal quality or ensure a more robust connection. Access point 205, on the other hand, only supports low bandwidth data systems. Based on this criteria, the master controller 20 will assign the higher gain/narrower beam antenna 15 to the access point 200 and the lower gain/wider beam antenna 16 to the access point 205. In other embodiments, certain signals may carry data which can reduce the number of nodes in the mesh network and which if lost, would require additional links to be added to the mesh network in order to maintain the required connectivity for all vehicles.

It shall be understood that the above criteria and ranking examples are not exhaustive, and may be combined to produce hybrid rankings and corresponding assignments. For example, each of the above parameters may be assigned a weight to be used when factoring multiple parameters into the criteria.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

What is claimed is:

1. A method for automatically coordinating different remote broadband communications sources using substantially different directional antennas mounted on a single vehicle and automatically tracking in accord with the coordination, comprising:
identifying a first signal received from a first remote broadband communication source, the first signal having a first signal characteristic;
identifying a second signal received from a second remote broadband communication source, the second signal having a second signal characteristic substantially different from the first signal characteristic;
automatically directing a first one of the plurality of vehicle-mounted directional antennas to receive and automatically track the first signal, wherein the automatically directing includes a selection of the pairings between the signals and antennas based on an optimization criteria, the optimization criteria taking into account differences in the antenna characteristics and differences in the signal characteristics; and
automatically directing a second one of the plurality of vehicle-mounted directional antennas substantially different from said first antenna to receive and automatically track the second signal.

2. The method of claim 1,
wherein the optimization criteria comprises assigning the first antenna to the first signal when the first signal is substantially weaker than the second signal and the first antenna has superior reception properties than the second antenna with respect to the first signal.

3. The method of claim 2, wherein the first antenna has a higher gain than the second antenna.

4. The method of claim 2, wherein the first antenna exhibits superior reception than the second antenna due to the relative mounting locations of the antennas on the vehicle.

5. The method of claim 1,
wherein the optimization criteria comprises assigning the first antenna to the first signal when the first signal originates from a more distant source than the second signal and the first antenna has superior reception properties than the second antenna with respect to the first signal.

6. The method of claim 5,
wherein the distance between the vehicle and at least one of the first and second sources is based upon GPS information.

7. The method of claim 1,
wherein the optimization criteria comprises assigning the first antenna to the first signal when the first signal originates from a source which is predicted to be relatively further away from the vehicle than the second source at a future point in time and the first antenna is predicted to have superior reception properties than the second antenna with respect to the first signal at the future point in time.

8. The method of claim 1,
wherein the optimization criteria comprises assigning the first antenna to the first signal when a first distance between the first source and the vehicle is increasing at a faster rate than a second distance between the second source and the vehicle, and when the first antenna has superior reception properties than the second antenna with respect to the first signal.

9. The method of claim 1,
wherein the optimization criteria comprises assigning the first antenna to the first signal when the first source includes a network topology manager and the first antenna has superior reception properties than the second antenna with respect to the first signal.

10. The method of claim 1,
wherein the optimization criteria comprises assigning the first antenna to the first signal when the first source has a relatively lower number of wireless links to a network topology manager than the second source and the first antenna has superior reception properties than the second antenna with respect to the first signal.

11. The method of claim 1,
wherein the optimization criteria comprises assigning the first antenna to the first signal when the first signal has a substantially higher bandwidth than the second signal and the first antenna has superior reception properties than the second antenna with respect to the first signal.

12. The method of claim 1,
wherein the optimization criteria comprises assigning the first antenna to the first signal when the first signal carries data types which require greater bandwidth than the second signal and the first antenna has superior reception properties than the second antenna with respect to the first signal.

13. The method of claim 1,
wherein the optimization criteria comprises assigning the first antenna to the first signal when the first signal carries higher priority data than the second signal and the first antenna has superior reception properties than the second antenna with respect to the first signal.

14. The method of claim 13 in which the higher priority data is voice over internet protocol data.

15. The method of claim 13 in which the higher priority data is data that can reduce the number of nodes in a mesh network, and thus reduce the latency of the data.

16. The method of claim 1, further comprising:
detecting that the quality of at least one of the first and second signals has fallen below a threshold value; and
automatically directing the antenna associated with the lost signal to focus toward the last known location of the lost signal source to reestablish communication with the lost signal source.

17. The method of claim 1, further comprising:
automatically repeating the steps identified in claim 1 if the quality of at least one of the first and second signals has fallen below a threshold value.

18. Apparatus for coordinating two antenna alignment and tracking systems on a single vehicle wherein said antennas have substantially different directional reception properties comprising,
a controller for operatively connecting to each of the two antenna alignment and tracking systems;
said controller containing information as to the different directional reception properties of the respective antennas and information as to different signal sources of interest;
said controller being configured for selecting pairings between the signals and antennas based on an optimization criteria, the optimization criteria taking into account differences in the antenna characteristics and differences in the signal characteristics; and
automatically providing control signals suitable for connection to the two antenna alignment and tracking systems to cause the coordinated automatic tracking of each antenna to receive the particular signal selected for it by said controller.
